(19) United States
(12) Patent Application Publication
(10) Pub. No.: US 2023/0117047 A1
(43) Pub. Date: Apr. 20, 2023

(54) SYSTEMS AND METHODS FOR ALLOCATING COMPUTE NODES IN A POWER-CONSTRAINED ENVIRONMENT

(71) Applicant: Microsoft Technology Licensing, LLC, Redmond, WA (US)

(72) Inventors: Robert Binneweg FRANCIS, Bothell, WA (US); Yunqiao XU, Bellevue, WA (US)

(21) Appl. No.: 17/502,936

(22) Filed: Oct. 15, 2021

(51) Int. Cl. G06F 9/48; G06F 9/50

(52) U.S. Cl. CPC G06F 9/4893; G06F 9/5094

(57) ABSTRACT

A method of managing computational and power resources in a datacenter includes receiving an application request at an allocator to execute a requested application, identifying an idle computing device in the datacenter, obtaining an efficiency parameter for the idle computing device, obtaining a normalized power demand of the requested application, and determining a device power demand for the requested application on the idle computing device based at least partially on the efficiency parameter and a normalized power demand for the requested application.

### BACKGROUND

### Background and Relevant Art

Bespoke, high-density server blades used for compute-heavy workloads (gaming, machine learning, etc.) may exceed the power and thermal limits of general-purpose server hardware. Such compute-heavy blades may have multiple servers, graphical processing units (GPUs), or application specific integrated circuits (ASICs) per blade chassis but slot into a conventional server rack design, which may be intended or designed for more moderate power-consuming blade configurations. For specialized, compute-heavy blade configurations to operate within the thermal and power constraints of conventional rack systems, aggressive power management strategies, like idling or powering off a proportion of servers, are conventionally required.

### BRIEF SUMMARY

In some embodiments, a method of managing computational and power resources in a datacenter includes receiving an application request at an allocator to execute a requested application, identifying an idle computing device in the datacenter, obtaining an efficiency parameter for the idle computing device, obtaining a normalized power demand of the requested application, and determining a device power demand for the requested application on the idle computing device based at least partially on the efficiency parameter and a normalized power demand for the requested application.

In some embodiments, a method for managing computational and power resources in a datacenter includes receiving an application request at an allocator to execute a requested application, identifying a first idle computing device in the datacenter, obtaining an efficiency parameter for the first idle computing device, identifying a second idle computing device in the datacenter, and obtaining an efficiency parameter for the second idle computing device. The method further includes obtaining a normalized power demand of the requested application, determining a first device power demand for the requested application on the first idle computing device based at least partially on the efficiency parameter and a normalized power demand for the requested application, determining a second device power demand for the requested application on the second idle computing device based at least partially on the efficiency parameter and a normalized power demand for the requested application, comparing the first device power demand to the second device power demand, and instructing the idle computing device with the lower device power demand to execute the requested application.

In some embodiments, a method for managing computational and power resources in a datacenter includes receiving telemetry information from a computing device executing an application, obtaining an efficiency parameter for the computing device, wherein the efficiency parameter indicates how power efficient the computing device is relative to an ideal computing device of the same hardware architecture, and calculating a normalized power demand for the application based at least partially on the efficiency parameter and the telemetry information.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a datacenter, according to at least some embodiments of the present disclosure;

FIG. 2 is a schematic representation of a computing device, according to at least some embodiments of the present disclosure;

FIG. 3 is a schematic representation of a server rack in a datacenter, according to at least some embodiments of the present disclosure;

FIG. 4 is a schematic representation of an allocator communicating with a plurality of computing devices, according to at least some embodiments of the present disclosure;

FIG. 5 is a flowchart illustrating a method of allocating compute resources, according to at least some embodiments of the present disclosure; and

FIG. 6 is a flowchart illustrating another method of allocating compute resources in a datacenter, according to at least some embodiments of the present disclosure.

### DETAILED DESCRIPTION

The present disclosure relates generally to systems and methods for power and data management in a datacenter. More particularly, the present disclosure relates to allocating idle compute nodes to execute requested applications in a power-constrained environment. In conventional datacenters, electronic devices are shut down, throttled, disabled, or otherwise limited in response to power demands of the electronic devices exceeding the power supply limit of a server rack.

In some embodiments, the computing devices of a server rack have a maximum power consumption that exceeds a power supply limit of the server rack. The computing devices, if all operating at maximum capacity, will require more power than the power supply of the server rack can provide, causing a reduction in performance or failure of one or more of the computing devices. In a datacenter environment, remote users may be interacting with the computing devices in real-time. Degradation of performance and/or shutdown of the computing devices is therefore undesirable. To ensure a quality experience for users, conventional datacenters and/or server racks can power cap, throttle, or disable some devices to manage the power consumption of the server rack as a whole.

The requested applications can be allocated to individual computing devices based at least partially on how efficiently the computing devices can execute the requested application. In some instances, such as cloud-based gaming (such as AMAZON LUNA, GOOGLE STADIA, PLAYSTATION NOW, MICROSOFT XBOX CLOUD GAMING, etc.), the application or data that is requested by the user may be optimized for or more efficiently executed on certain hardware specifications and/or generations. Some hardware may be more efficient as certain rendering or post-processing operations, such as ray-traced lighting effects. Some hardware may be intrinsically more efficient based at least partially upon the manufacturing processes and/or variations within the manufacturing process.

An allocator or other management service may receive data from computing devices executing the requested application or accessing the requested data along with device information, such as hardware configurations (including central processing unit (CPU), system memory, graphical processing unit (GPU), non-volatile hardware storage devices, and other hardware components) or hardware parameters (such as Hovis parameters that indicate power efficiency of a processor or other IC) that indicate intrinsic efficiency. The allocator or other management service may create a normalized power draw for the application based on the known hardware properties of the computing devices executing the application. The allocator or other management service can then use the normalized power draw to determine the expected power draw for other computing devices before assigning the computing device to execute a requested application.

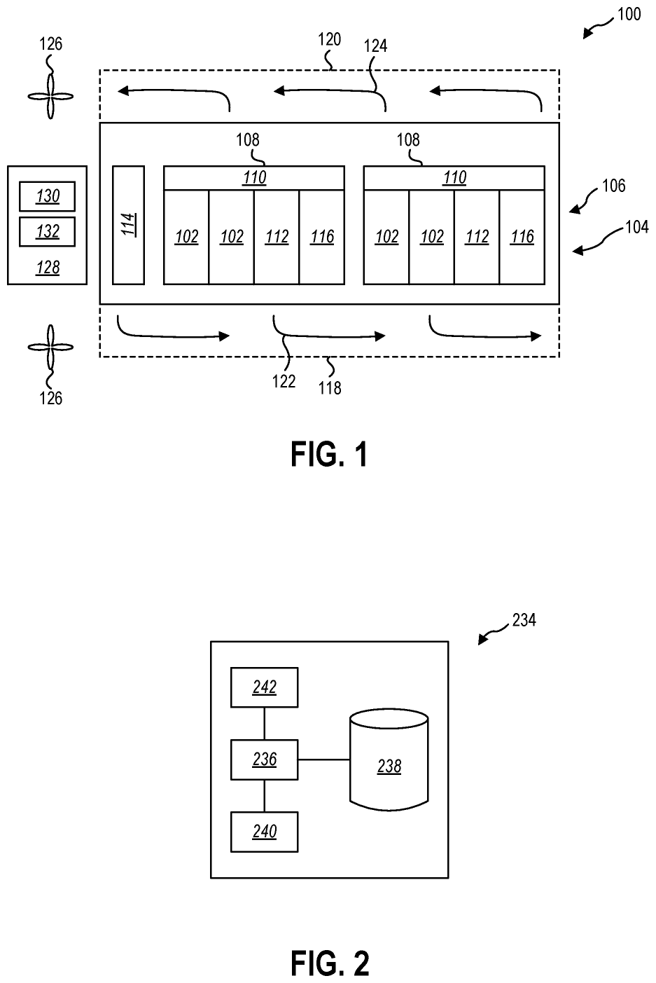

FIG. 1 is a schematic representation of a datacenter 100. In some embodiments, the datacenter 100 includes server blades 102 in a climate-controlled room 104. The server blades 102 are arranged in a row 106, where the row 106 contains a plurality of server racks 108, each of which contain at a plurality of server blades 102, power supplies 110, networking devices 112, and other electronic devices. In some examples, the server blade 102 includes a plurality of computing components. In some examples, the server computers are complete computers (e.g., each server computer can function as a standalone computer). In some examples, the server blades 102 include one or more computing devices that can cooperate to provide scalable computational power.

The server row 106 can include a row manager 114 that is in communication with the server racks 108 and/or rack manager 116 of the server row 106. In some embodiments, the row manager 114 controls computational loads, such as process allocations, of the server racks 108 and/or server blades 102. In doing so, the row manager 114 may control, at a high-level, the amount of power demanded of the power supply 110 by the server blades 102 of the server racks 108.

In datacenters where the server blades 102 house compute power that would, when operating at or near compute capacity, exceed the capacity of the power supply 110, the row manager 114 and/or rack manager 116 would conventionally power down or cap one or more of the computing devices or server blades 102 in the row 106. Allocating computing devices to execute requested applications based on which computing devices execute the requested application most efficiently would distribute power intelligently to limit the need to cap or throttle power to the computing devices.

In some instances, the power supply 110 may be capable of providing sufficient power to the server blades 102 when the computing devices of the server blades 102 are operating at or near compute capacity, but the amount of heat generated by the server blades 102 when operating at or near compute capacity may exceed the thermal management capacity of the datacenter 100 or room 104.

Allocating computing devices to execute requested applications based on which computing devices execute the requested application most efficiently would reduce overall heat in the server rack and/or row, allowing the thermal management to operate more efficiently, further reducing power consumption and/or improving performance.

In some embodiments, the row manager 114 controls thermal management of the server racks and/or server computers. For example, the row manager 114 can manage active thermal management for the server racks 108 and/or server blades 102 by changing fan speed or by controlling the flow rate of a cooling fluid for liquid cooling systems. In at least one example, the server row 106 is at least partially cooled by a liquid cooling system that delivers cooling fluid to the server racks 108 of the server row 106. The row manager 114 is in communication with the cooling fluid pump to change or stop the flow of cooling fluid.

A server rack 108 can support a plurality of server blades 102 in the rack. The server computers may each have liquid cooling, such as localized immersion cooling for at least some electronic components of the server computer, or a cooling plate with recirculating cooling fluid to cool the electronic component(s) of the server computer. In some embodiments, the server blades 102 or other electronic devices may be air-cooled, utilizing a cold aisle 118 and a hot aisle 120 that flow colder air 122 from the cold aisle 118 and evacuate hotter air 124 from the electronic devices through the hot aisle 120. The air flows from the cold aisle 118 to the hot aisle 120 based on air pressure differentials established by pumps or fans 126 of the thermal management system in series with the cold aisle 118 and the hot aisle 120.

In some embodiments, the electronic components, such as server blades 102, of the server rack 108 are in data communication with a rack manager 116. The rack manager 116 may control power delivery to the server blades 102 or other electronic components. In conventional server arrays, the rack manager 116 may communicate with the server blades 102 or other electronic components to disable, power cap, or throttle the server blades 102 or other electronic components and manage power draw. The rack manager 116, in some embodiments, is also in communication with a cooling fluid pump that moves cooling fluid to one or more server computers or other electronic components in the server rack. While embodiments described herein will describe the management of power draw due to computing demands, it should be understood that a reduction in computing power draw can result in an additional reduction in thermal management power draw, compounding the benefits of systems and methods according to the present disclosure.

An allocator 128, control plane, or other service manager may be in data communication with one or more of the server blades 102 (and components thereof), the power supply 110, the network device 112, the row manager 114, and/or rack manager(s) 116. In some embodiments, the allocator 128 is provided by a processor 130 and a hardware storage device 132. The allocator 128 receives requests from users for requested applications or requested data, and the allocator 128 assigns computing devices of the server blades 102 to perform or provide the requested tasks.

The processor 130 may receive information from the server blades 102 (and components thereof), the power supply 110, the network device 112, the row manager 114, and/or rack manager(s) 116, that allow the processor to perform any of the methods described herein. In some embodiments, the devices in communication with the allocator 128 may receive instructions from the allocator 128 to alter the operation and/or communication of the devices. For example, the allocator 128 may communicate with the server blades 102 and/or the computing devices of the server blades 102 to efficiently use the data and compute resources available on the server blades 102.

The hardware storage device 132 can be any non-transient computer readable medium that may store instructions thereon. The hardware storage device 132 may be any type of solid-state memory; volatile memory, such as static random access memory (SRAM) or dynamic random access memory (DRAM); non-volatile memory, such as read-only memory (ROM) including programmable ROM (PROM), erasable PROM (EPROM) or EEPROM; magnetic storage media, such as magnetic tape; a platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory; or any other non-transient storage media.

The allocator 128 may be local to the datacenter 100 (e.g., on site at the datacenter), local to the row 104, or local to the rack 108 to allow communication between the server blades 102 and the allocator 128. In some embodiments, the allocator 128 is remote to the datacenter 100, allowing the allocator 128 to be housed and/or controlled remotely, such as from a regional datacenter that communicates with the local datacenter 100.

FIG. 2 is a schematic representation of a computing device 234 located on a server blade, such as the server blades 102 described in relation to FIG. 1. In some embodiments, the computing device 234 includes at least a processor 236, a hardware storage device 238, and a network device 240. In some examples, the computing device 234 may include additional or dedicated components such as a graphical processing unit (GPU) 242, a central processing unit (CPU), system memory, graphical memory, audio processing unit, physics processing unit, wireless communication devices, or other electronic components or ASICs. The processor 236 is in data communication with the hardware storage device 238 to execute instructions stored on the hardware storage device 238.

In some embodiments, the computing device 234 is or includes gaming computing hardware. For example, the computing device 234 may include one or more processors or hardware storage devices specified in retail commodity video game hardware. The current generation of retail commodity video game hardware (e.g., SONY PLAYSTATION 5, MICROSOFT XBOX SERIES X, etc.) includes high-speed solid-state storage, such as NVMe storage. The NVMe storage is rated for transfers rates, both read and write speeds, that allow the game applications intended for the retail commodity video game hardware to run properly. In other examples, the CPU and/or GPU of the computing device 234 may be the same or similar CPU and/or GPU found in the retail commodity video game hardware to allow the game applications intended for the retail commodity video game hardware to run properly.

However, while the NVMe hard drives allow for high data transfer rates, NVMe hard drives have a relatively low storage capacity compared to other forms of data storage, such as magnetic hard disk drives. Therefore, the individual computing device 234 may be limited in the total storage capacity, and hence the variety of content available on the computing device 234. Similarly, the CPU and/or GPU may have a sufficient computing capacity to execute the game applications intended for the retail commodity video game hardware, while a power supply of a server rack is unable to provide sufficient power for a plurality of computing devices 234 in the server rack. Therefore, the allocator (such as the allocator 128 described in relation to FIG. 1) may use a device inventory and data inventory to identify an available or idle computing device with the requested application or data stored on a local hardware storage device and on a server rack with available power necessary for the computing task.

The plurality of computing devices 234, may all execute instructions stored locally on a hardware storage device 238 of the computing device 234 and remain independent of other computing devices. For example, some game applications do not require the processor 236 and/or GPU 242 of the computing device 234 to operate at or near power consumption capacity. Each computing device 234 may, in such instances, be allowed to operate independently, as the total power demands of the computing devices remains below the power supply limit. While the present disclosure describes game applications and gaming usages, it should be understood that the systems and methods described herein are applicable to any use case that requires high computational throughput. In some embodiments, a first computing device may be more power efficient, either generally or specifically executing a requested application, than a second computing device and the allocator may preferentially assign the requested application to the more power efficient computing device.

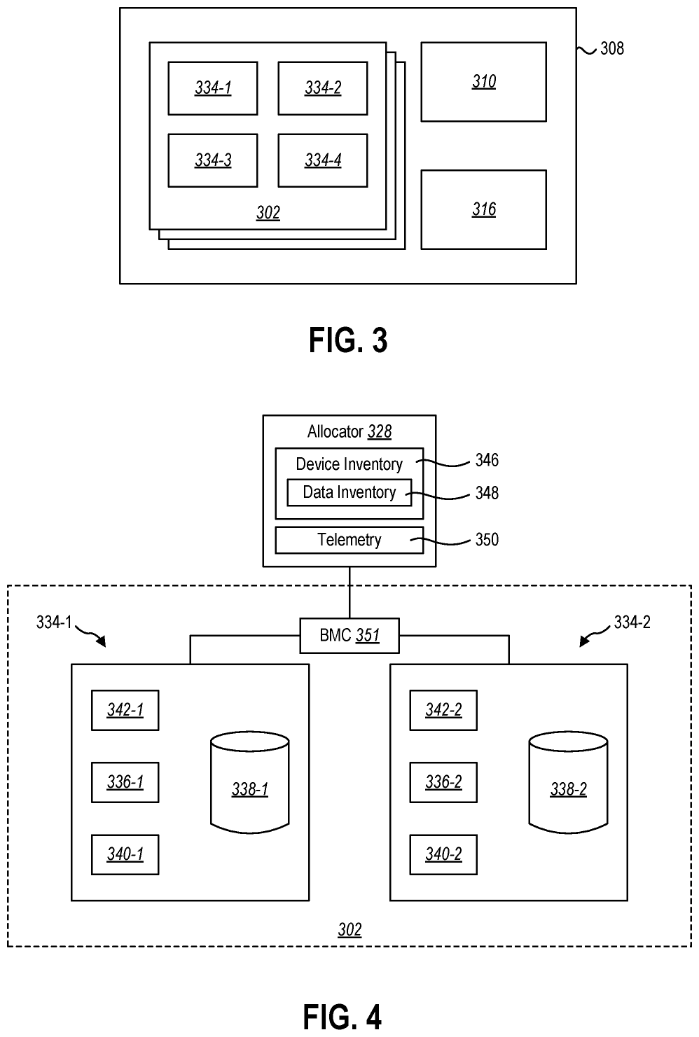

FIG. 3 is a schematic representation of four computing devices 334, such as those described in relation to FIG. 2, on a single server blade 302, such as that described in relation to FIG. 1. A server rack 308 may include a plurality of server blades 302, which each have a plurality of computing devices 334 thereon. The combined power demands of the computing devices 334 may exceed the power supply limit of a conventional server rack power supply 310. In conventional instances, the rack manager 316 of the rack 308 may throttle or disable one or more of the computing devices 334 available on the rack 308. The dense configuration of computational resources can provide a plurality of options for the allocator to assign requested applications or tasks.

During the manufacturing process, different computing devices 334 may be made more efficient or less power efficient based on tolerances during manufacturing. For example, any of the components of the computing devices 334 may have variations in energy efficiency for a given processing or data-handling task. In some embodiments, individual components may be tested during or after manufacturing to determine an efficiency parameter of the component, and the component efficiency parameters may be aggregated to determine a device efficiency parameter. In some embodiments, the computing device, as a whole, may be tested during or after manufacturing to determine the device efficiency parameter.

The efficiency parameter for each device may be used to calculate the power draw of the different computing devices 334-1, 334-2, 334-3, 334-4 for the same requested application. The allocator may then determine, for example, the first computing device 334-1 to be most power efficient for the requested application and assign the first computing device 334-1 to execute the requested application.

FIG. 4 is a schematic representation of an allocator 328 managing application assignments between the first computing device 334-1 and second computing device 334-2 described in relation to FIG. 3. In some embodiments, an allocator 328 can manage virtual machine (VM) and/or process allocation to the computing devices 334-1, 334-2 on a server blade 302, in the server rack, or in a row. In managing the VM and process allocation, the allocator 328 can create a device inventory 346 based on the device identification (IDs) of the computing devices 334-1, 334-2 in communication with the allocator 328. In some embodiments, the device inventory 346 can further include a data inventory 348 to allows for the allocator 328 to know what game applications, software application, or other data is physically stored on which devices in the device inventory 346.

In the illustrated embodiment of FIG. 4, the first computing device 334-1 and the second computing device 334-2 are located on a shared server blade 302 within a server rack. In other embodiments, the first computing device 334-1 and the second computing device 334-2 are located on different server blades 302 within a single server rack. In yet other embodiments, the first computing device 334-1 and the second computing device 334-2 are located on different server racks within a row. In further embodiments, the first computing device 334-1 and the second computing device 334-2 are located in different rows or datacenters.

The device inventory 346 may include device IDs and associated device locations for the devices in the network and/or within the datacenter. In some embodiments, the device locations include network location information related to the physical proximity of the devices in the device inventory. For example, a first computing device 334-1 and a second computing device 334-2 may be identified within the device inventory 346 as being located on the same server blade 302, in the same rack, in the same row, in the same datacenter, etc. The relative physical location of the first computing device 334-1 and second computing device 334-2 may affect latency or connection quality to a remote user of the requested application running on the first computing device 334-1 or the second computing device 334-2, and the physical location of the devices may be considered by the allocator 328 in addition to power efficiency and power overhead within a given server rack.

The data inventory 348 may include software IDs for one or more game applications or software applications. The software IDs or other information in the data inventory 348 may include information about genre, normalized power draw, network demands, etc. of the requested game application or software application. The data inventory 348 may further include file names, directory names, or other identifying information for the data stored on the devices in the device inventory 346. The data inventory 348 can, therefore, associate the data and/or applications with a network or physical location of the device on which the data is stored. The allocator 328 can determine whether requested data or a requested application is present on the devices controlled by the allocator 328, and the allocator 328 can identify the network or physical location of the requested data or application. If the requested data or application is available on a hardware storage device (e.g., 338-1, 338-2), the allocator 328 may use the device inventory 346 to identify the locations of the requested data or application.

System telemetry 350 can assist the allocator 328 in VM and process allocation of the computing devices 334-1, 334-2 and data stored thereon. For example, the allocator 328 or other management service may communicate with the computing devices 334-1, 334-2 and power supply of the rack to measure one or more real-time properties of the computing device(s), the power supply, network switch, or other electronic devices of the server rack, row, or datacenter. The telemetry 350 can include power draw from the computing devices, processor load, memory usage, network usage, temperature, or other properties of the system that reflect performance and operation. In some embodiments, the computing devices 334-1, 334-2 may communicate to the allocator 328 the current application or applications running on the computing device 334-1, 334-2. The power draw information can allow the allocator 328 to determine when the power draw of the computing device, a server blade, or all of the electronic devices in a rack is approaching or exceeding a power threshold value.

The allocator 328 can then receive the telemetry 350 (including current power draw) of the server rack on which the computing device 334-1, 334-2 is located, and determine whether the expected power draw of each computing device 334-1, 334-2, when executing the requested application, would exceed the power overhead of the server rack.

In some embodiments, the telemetry 350 includes temperature data that is collected from one or more thermal sensors associated with the server rack, a server blade, a computing device, or a component of a computing device. The temperature data can allow the allocator to determine when the environment or specific components of a computing device are approaching or exceeding a thermal threshold value.

In some embodiments, the telemetry is received from a board management controller (BMC) 351 at the server blade 302. The BMC 351 may monitor the performance and/or operations of the computing devices 334-1, 334-2 and report the information to the allocator 328. In some embodiments, the allocator 328 may send at least some instructions to the computing devices 334-1, 334-2 via the BMC 351.

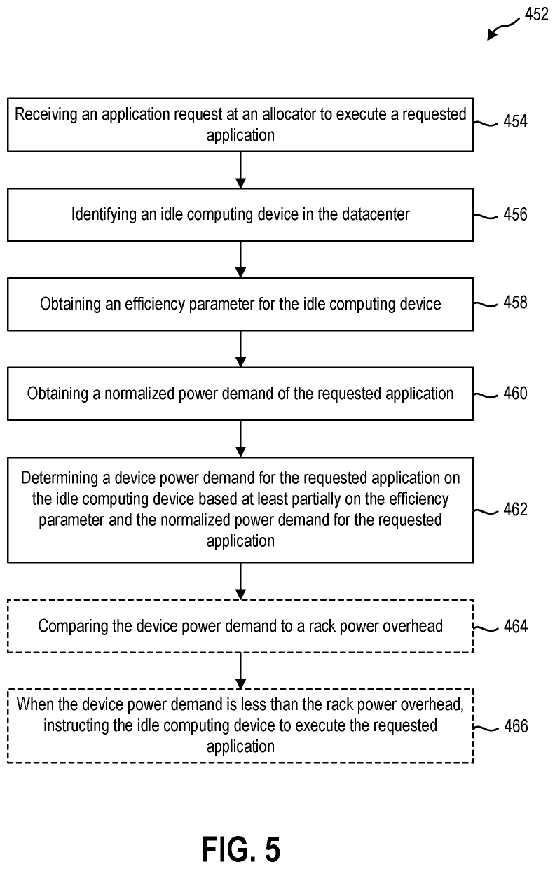

Referring now to FIG. 5, in some embodiments, a method 452 of controlling data and compute resources in a datacenter includes comparing a device power draw for a requested application to available power overhead on a server rack before assigning an idle computing device to execute the requested application. For example, at an allocator in data communication with at least a first computing device and a second computing device, where both the first computing device and the second computing device have a processor, a hardware storage device, and a network device, the method includes receiving an application request at the allocator to execute the requested application at 454. In some embodiments, a user sends an instruction to the allocator to execute the requested application at a datacenter, such that the user can interact with the requested application remotely.

The application request may include a request to execute the requested application. In some embodiments, the application request may include a request to execute the requested application at a particular resolution, a particular framerate, with particular graphics settings, or in a particular mode (such as a single-player or multiplayer gameplay mode). In at least one example, the request to execute the requested application may specify that a game application be run with particular graphical features, such as ray-traced lighting, enabled.

The method 452 further includes identifying an idle computing device in the datacenter that is able to execute the requested application at 456. In some embodiments, identifying the idle computing device includes accessing and/or using a device inventory and/or telemetry to identify an idle computing device with hardware compatible with executing the requested application. For example, the requested application may have recommended or required hardware specifications to execute the requested application. In some embodiments, the allocator accesses or uses a data inventory to identify an idle computing device that has the requested application stored locally on a hardware storage device of the idle computing device. In at least one embodiment, the allocator may assign a storage server to transmit the requested application to an idle computing device that does not have the requested application stored locally thereon. For example, the idle computing device may have the hardware components necessary to execute the requested application, and the idle computing device may execute the requested application by accessing the hardware storage device of a second computing device.

In some embodiments, the allocator receives a communication from a computing device where the communication includes a device ID. The allocator receives the communication and records the device ID and other information in the communication into a device inventory. The device inventory allows the allocator to identify the relative location and resources available in various devices in data communication with the allocator. In some examples, a computing device sends a communication to the allocator upon startup of the computing device. In at least one example, a server rack with a plurality of computing devices is initialized together, allowing the allocator to receive communications from the plurality of computing devices and create a device inventory for the plurality of computing devices in the server rack.

The communication to the allocator may further includes a software registry, library, or log, that informs the allocator of the applications or other data available on the computing device(s). For example, upon startup, a computing device may communicate with the allocator and inform the allocator of the computing device's network location, physical location, processing resource information, and what applications are stored thereon. The software information allows the allocator to create a data inventory based, in some instances, on the device inventory. The data inventory and device inventory may allow the allocator to find a requested software application or other data on a hardware storage device.

As described herein, the idle computing device has an efficiency parameter (such as a Hovis parameter) associated with the idle computing device that is determined at or after manufacturing that indicates how power efficient the computing device is relative to other computing devices. In some embodiments, the method 452 includes obtaining an efficiency parameter for the idle computing device at 458 and obtaining a normalized power demand for the requested application at 460.

Obtaining the efficiency parameter for the idle computing device may include requesting and/or receiving the efficiency parameter from the idle computing device. For example, the allocator may send an efficiency request to the idle computing device, and the idle computing device may transmit to the allocator an efficiency parameter that is stored on a hardware storage device of the idle computing device. As described herein, device IDs may be sent upon startup or upon request and include the efficiency parameter for each computing device.

In some embodiments, obtaining the efficiency parameter for the idle computing device includes accessing a device inventory that includes the idle computing device. The device inventory may have stored therein efficiency parameters at least the idle computing device to inform the allocator as to the relative efficiency of the idle computing device. In some embodiments, obtaining the efficiency parameter includes requesting and/or receiving a device inventory containing the efficiency parameters therein from a remote source, such as another server.

The normalized power demand for the requested application may be obtained from the data inventory and/or the device inventory accessed by the allocator. In some embodiments, the normalized power demand for the requested application is provided by a developer of the application and may be obtained from a third-party server. In some embodiments, the normalized power demand is measured from telemetry of computing devices executing the requested application. For example, the normalized power demand may be calculated by measuring the power draw of a computing device when executing the requested application. Telemetry from a computing device with a known efficiency parameter executing the application can be used to calculate the normalized power demand of the application. For example, a first computing device that has a known efficiency parameter of 1.3 relative to an ideally efficient computing device (e.g., 30% higher power consumption than an ideal computing device) that reports a 195 Watt (W) power draw while executing the application indicates the application has a 150 W normalized power draw.

In some embodiments, a plurality of normalized power demand calculations from the same computing device or from a variety of computing devices with different efficiency parameters may allow the normalized power demand to be refined over time for the application. In some examples, the normalized power demands calculated each time may be averaged to refine the normalized power demand stored at the allocator and/or with the application data. In other examples, a machine learning model may be used to refine and/or predict the normalized power demand for an application based on similar applications executed on similar hardware architecture.

While the most directly relevant data may be collected from identical computing devices executing the same game, a machine learning model may predict the power demand of a requested application based on normalized power demands calculated from a different generation of computing device. For example, rendering High Definition three-dimension environments on previous generation computing devices may have a normalized power demand of 200 W, while current generation computing devices may draw approximately 15% less power. Similarly, newer technologies may add graphical effects or post-processing that increase a normalized power demand. In at least one example, MICROSOFT XBOX SERIES X game consoles allow for retroactive calculation and application of High Dynamic Range effects on previous generation games, whereas XBOX ONE architecture does not include the HDR effects on the same games. Executing the game application on a SERIES X game console, therefore, may cause a different normalized power demand, and the ML model may be able to predict the impact on the XBOX ONE normalize power demand by calculating the power demand impact of the retroactive HDR processing from other game applications with the retroactive HDR processing.

The normalized power demand may include a peak power demand and/or an average power demand. In some embodiments, a server rack may have an upper limit to the power the server rack may supply, and the peak power demand of the application may be used to determine whether a computing device on the server rack can execute the application. In some embodiments, the server rack may be able to provide power for brief periods above the upper limit, and the average power demand of the application may be used to determine whether a computing device on the server rack can execute the application. In some embodiments, the normalized power demand is between the average power demand and the peak power demand, such as an 80^{th} percentile power demand, a 90^{th} percentile power demand, a 95^{th} percentile power demand, etc. Similar to the request for the requested application, the normalized power demand may be specific to a particular gameplay mode, graphical setting, resolution, etc. The normalized power demand is specific to a hardware architecture. In at least one example, the GPU of the XBOX SERIES X hardware architecture can process ray-traced lighting more efficiently than XBOX ONE hardware architecture. Therefore, the normalized power demand used to calculate the device power demand for a game application with ray-traced lighting on a XBOX SERIES X hardware architecture may be different than the normalized power demand used to calculate the device power demand for the same game application with ray-traced lighting on a XBOX ONE hardware architecture.

In some embodiments, the normalized power demand is selected from a set of normalized power demands for the requested application. For example, the normalized power demands for the requested application may include different normalized power demands based on the graphical settings selected or based on the different hardware architectures, such as described herein.

A ML model according to the present disclosure refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some implementations, a machine learning system, model, or neural network described herein is an artificial neural network. In some implementations, a machine learning system, model, or neural network described herein is a convolutional neural network. In some implementations, a machine learning system, model, or neural network described herein is a recurrent neural network. In at least one implementation, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs. In at least one embodiment, the ML model is a supervised or semi-supervised model that is training using a plurality of known power draw amounts for a specific game application.

The method 452 further includes determining a device power demand for the requested application on the idle computing device based at least partially on the efficiency parameter and the normalized power demand of the requested application at 462. In some embodiments, the allocator may determine the device power demand by multiplying the normalized power demand by the efficiency parameter to determine how much power the idle computing device, particularly, will draw when executing the requested application.

The rack power supply delivers electrical power to the computing devices housed therein, and the rack power supply limit is a maximum wattage that the power supply can sustain to the devices therein. If the demands of the devices in the server rack exceed the power supply limit, the power will be insufficient to support the operation of at least one of the computing devices, causing the computing device(s) to slow, shut down, or fail.

The method 452 may, optionally, further include comparing the device power demand against a rack power overhead at 464. The rack power overhead is the amount of excess capacity in the server rack between the power supply limit for the server rack and the current power draw on the server rack. The power supply limit for the server rack should be understood as the limit the power supply can provide the server blades and/or computing devices for processing tasks. There may be other power demands on the server rack, such as networking switches or thermal management devices, but, for the purposes of determining whether a computing device can execute the requested application, the power supply limit should be understood to refer to the power available for processing.

In some embodiments, obtaining the power supply limit includes accessing or parsing a device ID of the power supply or device inventory. The power supply may have a rate power supply limit that is provided by the power supply in communication with an allocator or rack manager. In some embodiments, the power supply limit is a recorded or operator-provided value that is set based on the devices powered by the power supply. For example, the operator-provided limit may be less than the rated power supply limit to provide an additional safety factor when operating the server rack.

The current power draw on the server rack may be determined from, at least, the telemetry (such as the telemetry 350 described in relation to FIG. 4) from the server rack. For example, the resource telemetry may measure or otherwise provide to the allocator a total power draw for the server rack, a power draw from a server blade, a power draw from a specific computing device, or power draw from a specific component of a computing device. In some embodiments, the resource telemetry may measure or otherwise provide to the allocator a temperature of the room, the row, the rack, or one or more computing devices. In some embodiments, the resource telemetry may measure or otherwise provide to the allocator processor usage, memory usage, network usage, or other performance metrics of one or more computing devices.

The current power draw may be calculated by summing the power draw telemetry for all of the computing devices or all of the server blades on the server rack. In one example, a server rack may have a power supply limit (for processing operations) of 2000 W, and the current power draw on the server rack by the server blades may be 1600 W, providing a rack power overhead of 400 W available for additional processing.

After comparing the device power demand to the rack power overhead, when the device power demand is less than the rack power overhead, the method 452 may include instructing the idle computing device to execute the requested application at 466. In the provided example above, the normalized power demand was 150 W and the rack power overhead was 400 W. If the idle computing device has an efficiency parameter indicating the idle computing device is, for example, 10% less efficient than an ideal computing device, the device power demand of 165 W is well within the rack power overhead and the allocator instructs the idle computing device to execute the requested application.

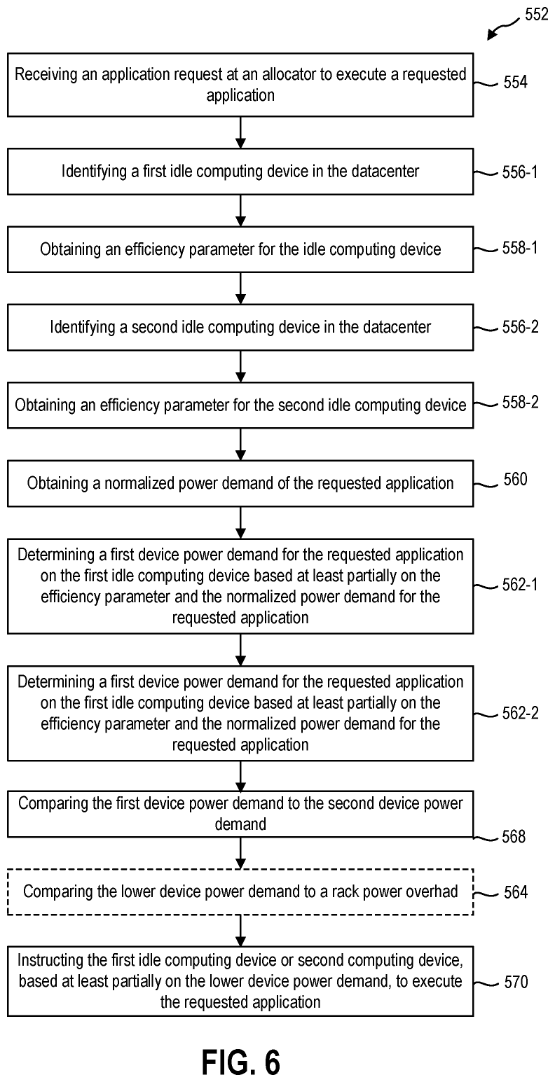

FIG. 6 illustrates another embodiment of a method 552 of controlling data and compute resources in a datacenter. In some embodiments, the allocator may determine device power demands for a plurality of computing devices using a normalized power demand to determine the more power efficient computing device to assign a requested application or task. In some embodiments, the method 552 includes receiving an application request at the allocator to execute the requested application at 554. In some embodiments, a user sends an instruction to the allocator to execute the requested application at a datacenter, such that the user can interact with the requested application remotely.

The application request may include a request to execute the requested application. In some embodiments, the application request may include a request to execute the requested application at a particular resolution, a particular framerate, with particular graphics settings, or in a particular mode (such as a single-player or multiplayer gameplay mode). In at least one example, the request to execute the requested application may specify that a game application be run with particular graphical features, such as ray-traced lighting, enabled.

The method 552 further includes identifying a first idle computing device in a datacenter that is able to execute the requested application at 556-1 and a identifying a second idle computing device in a datacenter that is able to execute the requested application at 556-2. The first idle computing device and second idle computing device may be located in the same datacenter or different datacenters. In some embodiments, identifying the idle computing device includes accessing and/or using a device inventory and/or telemetry to identify an idle computing device with hardware compatible with executing the requested application. For example, the requested application may have recommended or required hardware specifications to execute the requested application. In some embodiments, the allocator accesses or uses a data inventory to identify a first idle computing device and second idle computing device that has the requested application stored locally on a hardware storage device of the first idle computing device and second idle computing device. In at least one embodiment, the allocator may assign a storage server to transmit the requested application to an idle computing device that does not have the requested application stored locally thereon. For example, an idle computing device may have the hardware components necessary to execute the requested application, and the idle computing device may execute the requested application by accessing the hardware storage device of a computing device.

In some embodiments, the allocator receives a communication from a computing device where the communication includes a device ID. The allocator receives the communication and records the device ID and other information in the communication into a device inventory. The device inventory allows the allocator to identify the relative location and resources available in various devices in data communication with the allocator. In some examples, a computing device sends a communication to the allocator upon startup of the computing device. In at least one example, a server rack with a plurality of computing devices is initialized together, allowing the allocator to receive communications from the plurality of computing devices and create a device inventory for the plurality of computing devices in the server rack.

The communication to the allocator may further include a software registry, library, or log, that informs the allocator of the applications or other data available on the computing device(s). For example, upon startup, a computing device may communicate with the allocator and inform the allocator of the computing device's network location, physical location, processing resource information, and what applications are stored thereon. The software information allows the allocator to create a data inventory based, in some instances, on the device inventory. The data inventory and device inventory may allow the allocator to find a requested software application or other data on a hardware storage device.

As described herein, the first idle computing device and second idle computing device have an efficiency parameter (such as a Hovis parameter) associated with each of the first idle computing device and second idle computing device, respectively, that is determined at or after manufacturing that indicates how power efficient the computing devices are relative to other computing devices. In some embodiments, the method 552 includes obtaining a first efficiency parameter for the first idle computing device at 558-1 and obtaining a second efficiency parameter for the second idle computing device at 558-2. The method 552 further includes obtaining a normalized power demand for the requested application at 560 when the first idle computing device and second idle computing device have the same hardware architecture, such as game consoles. In some embodiments, the first idle computing device and second idle computing device have different hardware architectures, such as general-purpose or gaming-specific server computers, and a different normalized power demand is obtained for each hardware architecture.

In some embodiments, the method includes determining a first device power demand for the requested application on the first idle computing device based at least partially on the first efficiency parameter and the normalized power demand of the requested application at 562-1 and determining a second device power demand for the requested application on the second idle computing device based at least partially on the second efficiency parameter and the normalized power demand of the requested application at 562-2. In some embodiments, the allocator may determine a device power demand by multiplying the normalized power demand by the efficiency parameter to determine how much power the idle computing device, particularly, will draw when executing the requested application, such as described in relation to FIG. 5.

The method 552 further includes comparing the first device power demand to the second device power demand at 568. The allocator may determine which of the first idle computing device and second idle computing device will execute the requested application with a lower power draw and attempt to assign the computing device with the lower device power demand to execute the requested application. In some embodiments, the method 564 optionally includes comparing the lower device power demand to a rack power overhead at 564 (similar to as described in relation to FIG. 5) to ensure the device with the lower device power demand can execute the requested application without exceeding a power supply limit of the server rack.

After comparing the first device power demand to the second device power demand and, optionally, comparing the lower device power demand to a rack power overhead, the method 552 includes instructing the computing device with the lower device power demand to execute the requested application. The allocator can, thereby, assign requested applications to idle computing devices not only by the specific efficiencies of the computing devices in the datacenter(s), but also by preferentially assigning the requested application to the more power efficient devices to reduce overall power consumption of the datacenter(s).

### INDUSTRIAL APPLICABILITY

The present disclosure relates generally to systems and methods for power and data management in a datacenter. More particularly, the present disclosure relates to allocating idle compute nodes to execute requested applications in a power-constrained environment. In conventional datacenters, electronic devices are shut down, throttled, disabled, or otherwise limited in response to power demands of the electronic devices exceeding the power supply limit of a server rack.

In some embodiments, the computing devices of a server rack have a maximum power consumption that exceeds a power supply limit of the server rack. The computing devices, if all operating at maximum capacity, will require more power than the power supply of the server rack can provide, causing a reduction in performance or failure of one or more of the computing devices. In a datacenter environment, remote users may be interacting with the computing devices in real-time. Degradation of performance and/or shutdown of the computing devices is therefore undesirable. To ensure a quality experience for users, conventional datacenters and/or server racks can power cap, throttle, or disable some devices to manage the power consumption of the server rack as a whole.

The requested applications can be allocated to individual computing devices based at least partially on how efficiently the computing devices can execute the requested application. In some instances, such as cloud-based gaming (such as AMAZON LUNA, GOOGLE STADIA, PLAYSTATION NOW, MICROSOFT XBOX CLOUD, etc.), the application or data that is requested by the user may be optimized for or more efficiently executed on certain hardware specifications and/or generations. Some hardware may be more efficient as certain rendering or post-processing operations, such as ray-traced lighting effects. Some hardware may be intrinsically more efficient based at least partially upon the manufacturing processes and/or variations within the manufacturing process.

An allocator or other management service may receive data from computing devices executing the requested application or accessing the requested data along with device information, such as hardware configurations (including central processing unit (CPU), system memory, graphical processing unit (GPU), non-volatile hardware storage devices, and other hardware components) or hardware parameters (such as Hovis parameters that indicate power efficiency of a processor or other IC) that indicate intrinsic efficiency. The allocator or other management service may create a normalized power draw for the application based on the known hardware properties of the computing devices executing the application. The allocator or other management service can then use the normalized power draw to determine the expected power draw for other computing devices before assigning the computing device to execute a requested application.

In some embodiments, the datacenter includes server blades in a climate-controlled room. The server blades are arranged in a row, where the row contains a plurality of server racks, each of which contain at a plurality of server blades, power supplies, networking devices, and other electronic devices. In some examples, the server blade includes a plurality of computing components. In some examples, the server computers are complete computers (e.g., each server computer can function as a standalone computer). In some examples, the server blades include one or more computing devices that can cooperate to provide scalable computational power.

The server row can include a row manager that is in communication with the server racks and/or rack manager of the server row. In some embodiments, the row manager controls computational loads, such as process allocations, of the server racks and/or server blades. In doing so, the row manager may control, at a high-level, the amount of power demanded of the power supply by the server blades of the server racks.

In datacenters where the server blades house compute power that would, when operating at or near compute capacity, exceed the capacity of the power supply, the row manager and/or rack manager would conventionally power down or cap one or more of the computing devices or server blades in the row. Allocating computing devices to execute requested applications based on which computing devices execute the requested application most efficiently would distribute power intelligently to limit the need to cap or throttle power to the computing devices.

In some instances, the power supply may be capable of providing sufficient power to the server blades when the computing devices of the server blades are operating at or near compute capacity, but the amount of heat generated by the server blades when operating at or near compute capacity may exceed the thermal management capacity of the datacenter or room. Allocating computing devices to execute requested applications based on which computing devices execute the requested application most efficiently would reduce overall heat in the server rack and/or row, allowing the thermal management to operate more efficiently, further reducing power consumption and/or improving performance.

In some embodiments, the row manager controls thermal management of the server racks and/or server computers. For example, the row manager can manage active thermal management for the server racks and/or server blades by changing fan speed or by controlling the flow rate of a cooling fluid for liquid cooling systems. In at least one example, the server row is at least partially cooled by a liquid cooling system that delivers cooling fluid to the server racks of the server row. The row manager is in communication with the cooling fluid pump to change or stop the flow of cooling fluid.

A server rack can support a plurality of server blades in the rack. The server computers may each have liquid cooling, such as localized immersion cooling for at least some electronic components of the server computer, or a cooling plate with recirculating cooling fluid to cool the electronic component(s) of the server computer. In some embodiments, the server blades or other electronic devices may be air-cooled, utilizing a cold aisle and a hot aisle that flow colder air from the cold aisle and evacuate hotter air from the electronic devices through the hot aisle. The air flows from the cold aisle to the hot aisle based on air pressure differentials established by pumps or fans of the thermal management system in series with the cold aisle and the hot aisle.

In some embodiments, the electronic components, such as server blades, of the server rack are in data communication with a rack manager. The rack manager may control power delivery to the server blades or other electronic components. In conventional server arrays, the rack manager may communicate with the server blades or other electronic components to disable, power cap, or throttle the server blades or other electronic components and manage power draw. The rack manager, in some embodiments, is also in communication with a cooling fluid pump that moves cooling fluid to one or more server computers or other electronic components in the server rack. While embodiments described herein will describe the management of power draw due to computing demands, it should be understood that a reduction in computing power draw can result in an additional reduction in thermal management power draw, compounding the benefits of systems and methods according to the present disclosure.

An allocator, control plane, or other service manager may be in data communication with one or more of the server blades (and components thereof), the power supply, the network device, the row manager, and/or rack manager(s). In some embodiments, the allocator is provided by a processor and a hardware storage device. The allocator receives requests from users for requested applications or requested data, and the allocator assigns computing devices of the server blades to perform or provide the requested tasks.

The processor may receive information from the server blades (and components thereof), the power supply, the network device, the row manager, and/or rack manager(s), that allow the processor to perform any of the methods described herein. In some embodiments, the devices in communication with the allocator may receive instructions from the allocator to alter the operation and/or communication of the devices. For example, the allocator may communicate with the server blades and/or the computing devices of the server blades to efficiently use the data and compute resources available on the server blades.

The hardware storage device can be any non-transient computer readable medium that may store instructions thereon. The hardware storage device may be any type of solid-state memory; volatile memory, such as static random access memory (SRAM) or dynamic random access memory (DRAM); non-volatile memory, such as read-only memory (ROM) including programmable ROM (PROM), erasable PROM (EPROM) or EEPROM; magnetic storage media, such as magnetic tape; a platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory; or any other non-transient storage media.

The allocator may be local to the datacenter (e.g., on site at the datacenter), local to the row, or local to the rack to allow communication between the server blades and the allocator. In some embodiments, the allocator is remote to the datacenter, allowing the allocator to be housed and/or controlled remotely, such as from a regional datacenter or control center that communicates with the local datacenter.

In some embodiments, a computing device includes at least a processor, a hardware storage device, and a network device. In some examples, the computing device may include additional or dedicated components such as a graphical processing unit (GPU), a central processing unit (CPU), system memory, graphical memory, audio processing unit, physics processing unit, wireless communication devices, or other electronic components or ASICs. The processor is in data communication with the hardware storage device to execute instructions stored on the hardware storage device.

In some embodiments, the computing device is or includes gaming computing hardware. For example, the computing device may include one or more processors or hardware storage devices specified in retail commodity video game hardware. The current generation of retail commodity video game hardware (e.g., SONY PLAYSTATION 5, MICROSOFT XBOX SERIES X, etc.) includes high-speed solid-state storage, such as NVMe storage. The NVMe storage is rated for transfers rates, both read and write speeds, that allow the game applications intended for the retail commodity video game hardware to run properly. In other examples, the CPU and/or GPU of the computing device may be the same or similar CPU and/or GPU found in the retail commodity video game hardware to allow the game applications intended for the retail commodity video game hardware to run properly.

However, while the NVMe hard drives allow for high data transfer rates, NVMe hard drives have a relatively low storage capacity compared to other forms of data storage, such as magnetic hard disk drives. Therefore, the individual computing device may be limited in the total storage capacity, and hence the variety of content available on the computing device. Similarly, the CPU and/or GPU may have a sufficient computing capacity to execute the game applications intended for the retail commodity video game hardware, while a power supply of a server rack is unable to provide sufficient power for a plurality of computing devices in the server rack. Therefore, the allocator may use a device inventory and data inventory to identify an available or idle computing device with the requested application or data stored on a local hardware storage device and on a server rack with available power necessary for the computing task.

The plurality of computing devices may all execute instructions stored locally on a hardware storage device of the computing device and remain independent of other computing devices. For example, some game applications do not require the processor and/or GPU of the computing device to operate at or near power consumption capacity. Each computing device may, in such instances, be allowed to operate independently, as the total power demands of the computing devices remains below the power supply limit. While the present disclosure describes game applications and gaming usages, it should be understood that the systems and methods described herein are applicable to any use case that requires high computational throughput. In some embodiments, a first computing device may be more power efficient, either generally or specifically executing a requested application, than a second computing device and the allocator may preferentially assign the requested application to the more power efficient computing device.

A server rack may include a plurality of server blades, which each have a plurality of computing devices thereon. The combined power demands of the computing devices may exceed the power supply limit of a conventional server rack power supply. In conventional instances, the rack manager of the rack may throttle or disable one or more of the computing devices available on the rack. The dense configuration of computational resources can provide a plurality of options for the allocator to assign requested applications or tasks.

During the manufacturing process, different computing devices may be made more efficient or less power efficient based on tolerances during manufacturing. For example, any of the components of the computing devices may have variations in energy efficiency for a given processing or data-handling task. In some embodiments, individual components may be tested during or after manufacturing to determine an efficiency parameter of the component, and the component efficiency parameters may be aggregated to determine a device efficiency parameter. In some embodiments, the computing device, as a whole, may be tested during or after manufacturing to determine the device efficiency parameter.

The efficiency parameter for each device may be used to calculate the power draw of the different computing devices for the same requested application. The allocator may then determine, for example, the first computing device to be most power efficient for the requested application and assign the first computing device to execute the requested application.

In some embodiments, an allocator can manage virtual machine (VM) and/or process allocation to the computing devices on a server blade, in the server rack, or in a row. In managing the VM and process allocation, the allocator can create a device inventory based on the device identification (IDs) of the computing devices in communication with the allocator. In some embodiments, the device inventory can further include a data inventory to allows for the allocator to know what game applications, software application, or other data is physically stored on which devices in the device inventory.

In some embodiments, the first computing device and the second computing device are located on a shared server blade within a server rack. In other embodiments, the first computing device and the second computing device are located on different server blades within a single server rack. In yet other embodiments, the first computing device and the second computing device are located on different server racks within a row. In further embodiments, the first computing device and the second computing device are located in different rows or datacenters.

The device inventory may include device IDs and associated device locations for the devices in the network and/or within the datacenter. In some embodiments, the device locations include network location information related to the physical proximity of the devices in the device inventory. For example, a first computing device and a second computing device may be identified within the device inventory as being located on the same server blade, in the same rack, in the same row, in the same datacenter, etc. The relative physical location of the first computing device and second computing device may affect latency or connection quality to a remote user of the requested application running on the first computing device or the second computing device, and the physical location of the devices may be considered by the allocator in addition to power efficiency and power overhead within a given server rack.

The data inventory may include software IDs for one or more game applications or software applications. The software IDs or other information in the data inventory may include information about genre, normalized power draw, network demands, etc. of the requested game application or software application. The data inventory may further include file names, directory names, or other identifying information for the data stored on the devices in the device inventory. The data inventory can, therefore, associate the data and/or applications with a network or physical location of the device on which the data is stored. The allocator can determine whether requested data or a requested application is present on the devices controlled by the allocator, and the allocator can identify the network or physical location of the requested data or application. If the requested data or application is available on a hardware storage device, the allocator may use the device inventory to identify the locations of the requested data or application.

System telemetry can assist the allocator in VM and process allocation of the computing devices and data stored thereon. For example, the allocator or other management service may communicate with the computing devices and power supply of the rack to measure one or more real-time properties of the computing device(s), the power supply, network switch, or other electronic devices of the server rack, row, or datacenter. The telemetry can include power draw from the computing devices, processor load, memory usage, network usage, temperature, or other properties of the system that reflect performance and operation. In some embodiments, the computing devices may communicate to the allocator the current application or applications running on the computing device. The power draw information can allow the allocator to determine when the power draw of the computing device, a server blade, or all of the electronic devices in a rack is approaching or exceeding a power threshold value.

The allocator can then receive the telemetry (including current power draw) of the server rack on which the computing device is located and determine whether the expected power draw of each computing device, when executing the requested application, would exceed the power overhead of the server rack.

In some embodiments, the telemetry includes temperature data that is collected from one or more thermal sensors associated with the server rack, a server blade, a computing device, or a component of a computing device. The temperature data can allow the allocator to determine when the environment or specific components of a computing device are approaching or exceeding a thermal threshold value.

In some embodiments, the telemetry is received from a board management controller (BMC) at the server blade. The BMC may monitor the performance and/or operations of the computing devices and report the information to the allocator. In some embodiments, the allocator may send at least some instructions to the computing devices via the BMC.

In some embodiments, a method of controlling data and compute resources in a datacenter includes comparing a device power draw for a requested application to available power overhead on a server rack before assigning an idle computing device to execute the requested application. For example, at an allocator in data communication with at least a first computing device and a second computing device, where both the first computing device and the second computing device have a processor, a hardware storage device, and a network device, the method includes receiving an application request at the allocator to execute the requested application. In some embodiments, a user sends an instruction to the allocator to execute the requested application at a datacenter, such that the user can interact with the requested application remotely.

The application request may include a request to execute the requested application. In some embodiments, the application request may include a request to execute the requested application at a particular resolution, a particular framerate, with particular graphics settings, or in a particular mode (such as a single-player or multiplayer gameplay mode). In at least one example, the request to execute the requested application may specify that a game application be run with particular graphical features, such as ray-traced lighting, enabled.

The method further includes identifying an idle computing device in the datacenter that is able to execute the requested application. In some embodiments, identifying the idle computing device includes accessing and/or using a device inventory and/or telemetry to identify an idle computing device with hardware compatible with executing the requested application. For example, the requested application may have recommended or required hardware specifications to execute the requested application. In some embodiments, the allocator accesses or uses a data inventory to identify an idle computing device that has the requested application stored locally on a hardware storage device of the idle computing device. In at least one embodiment, the allocator may assign a storage server to transmit the requested application to an idle computing device that does not have the requested application stored locally thereon. For example, the idle computing device may have the hardware components necessary to execute the requested application, and the idle computing device may execute the requested application by accessing the hardware storage device of a second computing device.

In some embodiments, the allocator receives a communication from a computing device where the communication includes a device ID. The allocator receives the communication and records the device ID and other information in the communication into a device inventory. The device inventory allows the allocator to identify the relative location and resources available in various devices in data communication with the allocator. In some examples, a computing device sends a communication to the allocator upon startup of the computing device. In at least one example, a server rack with a plurality of computing devices is initialized together, allowing the allocator to receive communications from the plurality of computing devices and create a device inventory for the plurality of computing devices in the server rack.

The communication to the allocator may further includes a software registry, library, or log, that informs the allocator of the applications or other data available on the computing device(s). For example, upon startup, a computing device may communicate with the allocator and inform the allocator of the computing device's network location, physical location, processing resource information, and what applications are stored thereon. The software information allows the allocator to create a data inventory based, in some instances, on the device inventory. The data inventory and device inventory may allow the allocator to find a requested software application or other data on a hardware storage device.

As described herein, the idle computing device has an efficiency parameter (such as a Hovis parameter) associated with the idle computing device that is determined at or after manufacturing that indicates how power efficient the computing device is relative to other computing devices. In some embodiments, the method includes obtaining an efficiency parameter for the idle computing device and obtaining a normalized power demand for the requested application.

Obtaining the efficiency parameter for the idle computing device may include requesting and/or receiving the efficiency parameter from the idle computing device. For example, the allocator may send an efficiency request to the idle computing device, and the idle computing device may transmit to the allocator an efficiency parameter that is stored on a hardware storage device of the idle computing device. As described herein, device IDs may be sent upon startup or upon request and include the efficiency parameter for each computing device.

In some embodiments, obtaining the efficiency parameter for the idle computing device includes accessing a device inventory that includes the idle computing device. The device inventory may have stored therein efficiency parameters at least the idle computing device to inform the allocator as to the relative efficiency of the idle computing device. In some embodiments, obtaining the efficiency parameter includes requesting and/or receiving a device inventory containing the efficiency parameters therein from a remote source, such as another server.

The normalized power demand for the requested application may be obtained from the data inventory and/or the device inventory accessed by the allocator. In some embodiments, the normalized power demand for the requested application is provided by a developer of the application and may be obtained from a third-party server. In some embodiments, the normalized power demand is measured from telemetry of computing devices executing the requested application. For example, the normalized power demand may be calculated by measuring the power draw of a computing device when executing the requested application. Telemetry from a computing device with a known efficiency parameter executing the application can be used to calculate the normalized power demand of the application. For example, a first computing device that has a known efficiency parameter of 1.3 relative to an ideally efficient computing device (e.g., 30% higher power consumption than an ideal computing device) that reports a 195 Watt (W) power draw while executing the application indicates the application has a 150 W normalized power draw.

In some embodiments, a plurality of normalized power demand calculations from the same computing device or from a variety of computing devices with different efficiency parameters may allow the normalized power demand to be refined over time for the application. In some examples, the normalized power demands calculated each time may be averaged to refine the normalized power demand stored at the allocator and/or with the application data. In other examples, a machine learning model may be used to refine and/or predict the normalized power demand for an application based on similar applications executed on similar hardware architecture.

While the most directly relevant data may be collected from identical computing devices executing the same game, a machine learning model may predict the power demand of a requested application based on normalized power demands calculated from a different generation of computing device. For example, rendering High Definition three-dimension environments on previous generation computing devices may have a normalized power demand of 200 W, while current generation computing devices may draw approximately 15% less power. Similarly, newer technologies may add graphical effects or post-processing that increase a normalized power demand. In at least one example, MICROSOFT XBOX SERIES X game consoles allow for retroactive calculation and application of High Dynamic Range effects on previous generation games, whereas XBOX ONE architecture does not include the HDR effects on the same games. Executing the game application on a SERIES X game console, therefore, may cause a different normalized power demand, and the ML model may be able to predict the impact on the XBOX ONE normalize power demand by calculating the power demand impact of the retroactive HDR processing from other game applications with the retroactive HDR processing.

The normalized power demand may include a peak power demand and/or an average power demand. In some embodiments, a server rack may have an upper limit to the power the server rack may supply, and the peak power demand of the application may be used to determine whether a computing device on the server rack can execute the application. In some embodiments, the server rack may be able to provide power for brief periods above the upper limit, and the average power demand of the application may be used to determine whether a computing device on the server rack can execute the application. In some embodiments, the normalized power demand is between the average power demand and the peak power demand, such as an 80^{th} percentile power demand, a 90^{th} percentile power demand, a 95^{th} percentile power demand, etc. Similar to the request for the requested application, the normalized power demand may be specific to a particular gameplay mode, graphical setting, resolution, etc. The normalized power demand is specific to a hardware architecture. In at least one example, the GPU of the XBOX SERIES X hardware architecture can process ray-traced lighting more efficiently than XBOX ONE hardware architecture. Therefore, the normalized power demand used to calculate the device power demand for a game application with ray-traced lighting on a XBOX SERIES X hardware architecture may be different than the normalized power demand used to calculate the device power demand for the same game application with ray-traced lighting on a XBOX ONE hardware architecture.

In some embodiments, the normalized power demand is selected from a set of normalized power demands for the requested application. For example, the normalized power demands for the requested application may include different normalized power demands based on the graphical settings selected or based on the different hardware architectures, such as described herein.

A ML model according to the present disclosure refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some implementations, a machine learning system, model, or neural network described herein is an artificial neural network. In some implementations, a machine learning system, model, or neural network described herein is a convolutional neural network. In some implementations, a machine learning system, model, or neural network described herein is a recurrent neural network. In at least one implementation, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs. In at least one embodiment, the ML model is a supervised or semi-supervised model that is training using a plurality of known power draw amounts for a specific game application.

The method further includes determining a device power demand for the requested application on the idle computing device based at least partially on the efficiency parameter and the normalized power demand of the requested application. In some embodiments, the allocator may determine the device power demand by multiplying the normalized power demand by the efficiency parameter to determine how much power the idle computing device, particularly, will draw when executing the requested application.

The rack power supply delivers electrical power to the computing devices housed therein, and the rack power supply limit is a maximum wattage that the power supply can sustain to the devices therein. If the demands of the devices in the server rack exceed the power supply limit, the power will be insufficient to support the operation of at least one of the computing devices, causing the computing device(s) to slow, shut down, or fail.

The method may, optionally, further include comparing the device power demand against a rack power overhead. The rack power overhead is the amount of excess capacity in the server rack between the power supply limit for the server rack and the current power draw on the server rack. The power supply limit for the server rack should be understood as the limit the power supply can provide the server blades and/or computing devices for processing tasks. There may be other power demands on the server rack, such as networking switches or thermal management devices, but, for the purposes of determining whether a computing device can execute the requested application, the power supply limit should be understood to refer to the power available for processing.

In some embodiments, obtaining the power supply limit includes accessing or parsing a device ID of the power supply or device inventory. The power supply may have a rate power supply limit that is provided by the power supply in communication with an allocator or rack manager. In some embodiments, the power supply limit is a recorded or operator-provided value that is set based on the devices powered by the power supply. For example, the operator-provided limit may be less than the rated power supply limit to provide an additional safety factor when operating the server rack.

The current power draw on the server rack may be determined from, at least, the telemetry from the server rack. For example, the resource telemetry may measure or otherwise provide to the allocator a total power draw for the server rack, a power draw from a server blade, a power draw from a specific computing device, or power draw from a specific component of a computing device. In some embodiments, the resource telemetry may measure or otherwise provide to the allocator a temperature of the room, the row, the rack, or one or more computing devices. In some embodiments, the resource telemetry may measure or otherwise provide to the allocator processor usage, memory usage, network usage, or other performance metrics of one or more computing devices.

The current power draw may be calculated by summing the power draw telemetry for all of the computing devices or all of the server blades on the server rack. In one example, a server rack may have a power supply limit (for processing operations) of 2000 W, and the current power draw on the server rack by the server blades may be 1600 W, providing a rack power overhead of 400 W available for additional processing.

After comparing the device power demand to the rack power overhead, when the device power demand is less than the rack power overhead, the method may include instructing the idle computing device to execute the requested application. In the provided example above, the normalized power demand was 150 W, and the rack power overhead was 400 W. If the idle computing device has an efficiency parameter indicating the idle computing device is, for example, 10% less efficient than an ideal computing device, the device power demand of 165 W is well within the rack power overhead and the allocator instructs the idle computing device to execute the requested application.

In some embodiments, the allocator may determine device power demands for a plurality of computing devices using a normalized power demand to determine the more power efficient computing device to assign a requested application or task. In some embodiments, the method includes receiving an application request at the allocator to execute the requested application. In some embodiments, a user sends an instruction to the allocator to execute the requested application at a datacenter, such that the user can interact with the requested application remotely.

The application request may include a request to execute the requested application. In some embodiments, the application request may include a request to execute the requested application at a particular resolution, a particular framerate, with particular graphics settings, or in a particular mode (such as a single-player or multiplayer gameplay mode). In at least one example, the request to execute the requested application may specify that a game application be run with particular graphical features, such as ray-traced lighting, enabled.

The method further includes identifying a first idle computing device in a datacenter that is able to execute the requested application and a identifying a second idle computing device in a datacenter that is able to execute the requested application. The first idle computing device and second idle computing device may be located in the same datacenter or different datacenters. In some embodiments, identifying the idle computing device includes accessing and/or using a device inventory and/or telemetry to identify an idle computing device with hardware compatible with executing the requested application. For example, the requested application may have recommended or required hardware specifications to execute the requested application. In some embodiments, the allocator accesses or uses a data inventory to identify a first idle computing device and second idle computing device that has the requested application stored locally on a hardware storage device of the first idle computing device and second idle computing device. In at least one embodiment, the allocator may assign a storage server to transmit the requested application to an idle computing device that does not have the requested application stored locally thereon. For example, an idle computing device may have the hardware components necessary to execute the requested application, and the idle computing device may execute the requested application by accessing the hardware storage device of a computing device.

In some embodiments, the allocator receives a communication from a computing device where the communication includes a device ID. The allocator receives the communication and records the device ID and other information in the communication into a device inventory. The device inventory allows the allocator to identify the relative location and resources available in various devices in data communication with the allocator. In some examples, a computing device sends a communication to the allocator upon startup of the computing device. In at least one example, a server rack with a plurality of computing devices is initialized together, allowing the allocator to receive communications from the plurality of computing devices and create a device inventory for the plurality of computing devices in the server rack.

The communication to the allocator may further include a software registry, library, or log, that informs the allocator of the applications or other data available on the computing device(s). For example, upon startup, a computing device may communicate with the allocator and inform the allocator of the computing device's network location, physical location, processing resource information, and what applications are stored thereon. The software information allows the allocator to create a data inventory based, in some instances, on the device inventory. The data inventory and device inventory may allow the allocator to find a requested software application or other data on a hardware storage device.

As described herein, the first idle computing device and second idle computing device have an efficiency parameter (such as a Hovis parameter) associated with each of the first idle computing device and second idle computing device, respectively, that is determined at or after manufacturing that indicates how power efficient the computing devices are relative to other computing devices. In some embodiments, the method includes obtaining a first efficiency parameter for the first idle computing device and obtaining a second efficiency parameter for the second idle computing device. The method further includes obtaining a normalized power demand for the requested application when the first idle computing device and second idle computing device have the same hardware architecture, such as game consoles. In some embodiments, the first idle computing device and second idle computing device have different hardware architectures, such as general-purpose or gaming-specific server computers, and a different normalized power demand is obtained for each hardware architecture.

In some embodiments, the method includes determining a first device power demand for the requested application on the first idle computing device based at least partially on the first efficiency parameter and the normalized power demand of the requested application and determining a second device power demand for the requested application on the second idle computing device based at least partially on the second efficiency parameter and the normalized power demand of the requested application. In some embodiments, the allocator may determine a device power demand by multiplying the normalized power demand by the efficiency parameter to determine how much power the idle computing device, particularly, will draw when executing the requested application.

The method further includes comparing the first device power demand to the second device power demand. The allocator may determine which of the first idle computing device and second idle computing device will execute the requested application with a lower power draw and attempt to assign the computing device with the lower device power demand to execute the requested application. In some embodiments, the method optionally includes comparing the lower device power demand to a rack power overhead to ensure the device with the lower device power demand can execute the requested application without exceeding a power supply limit of the server rack.

After comparing the first device power demand to the second device power demand and, optionally, comparing the lower device power demand to a rack power overhead, the method includes instructing the computing device with the lower device power demand to execute the requested application. The allocator can, thereby, assign requested applications to idle computing devices not only by the specific efficiencies of the computing devices in the datacenter(s), but also by preferentially assigning the requested application to the more power efficient devices to reduce overall power consumption of the datacenter(s).

The present disclosure relates to systems and methods for balancing resource usage and data availability in a datacenter according to at least the examples provided in the sections below:

[A1] In some embodiments, a method of managing computational and power resources in a datacenter includes receiving an application request at an allocator to execute a requested application, identifying an idle computing device in the datacenter, obtaining an efficiency parameter for the idle computing device, obtaining a normalized power demand of the requested application, and determining a device power demand for the requested application on the idle computing device based at least partially on the efficiency parameter and a normalized power demand for the requested application.

[A2] In some embodiments, the efficiency parameter of [A1] is received from the idle computing device.

[A3] In some embodiments, the efficiency parameter of [A1] is obtained from a device inventory.

[A4] In some embodiments, the normalized power demand of any of [A1] through [A3] is selected from a set of normalized power demands for the requested application.

[A5] In some embodiments, the normalized power demand of any of [A1] through [A3] is selected from a set of normalized power demands at least partially based on one or more requested performance settings.

[A6] In some embodiments, the normalized power demand of any of [A1] through [A3] is selected from a set of normalized power demands at least partially based on one or more hardware parameters of the idle computing device.

[A7] In some embodiments, the method of any of [A1] through [A6] includes comparing the device power demand to a rack power overhead, and, when the device power demand is less than the rack power overhead, instructing the idle computing device to execute the requested application.

[A8] In some embodiments, the requested application of any of [A1] through [A7] is stored locally on a hardware storage device of the idle computing device.

[A9] In some embodiments, the normalized power demand of any of [A1] through [A8] is calculated by measuring telemetry from a second computing device with a second efficiency parameter executing the requested application.

[A10] In some embodiments, the second computing device of [A9] has the same hardware architecture as the idle computing device.

[A11] In some embodiments, the normalized power demand of any of [A1] through [A8] is calculated by a machine learning model that receives inputs from telemetry of a plurality of computing devices executing the requested application.

[A12] In some embodiments, at least one computing device of the plurality of computing devices of [A11] has a hardware architecture different from the idle computing device.

[B1] In some embodiments, a method for managing computational and power resources in a datacenter includes receiving an application request at an allocator to execute a requested application, identifying a first idle computing device in the datacenter, obtaining an efficiency parameter for the first idle computing device, identifying a second idle computing device in the datacenter, and obtaining an efficiency parameter for the second idle computing device. The method further includes obtaining a normalized power demand of the requested application, determining a first device power demand for the requested application on the first idle computing device based at least partially on the efficiency parameter and a normalized power demand for the requested application, determining a second device power demand for the requested application on the second idle computing device based at least partially on the efficiency parameter and a normalized power demand for the requested application, comparing the first device power demand to the second device power demand, and instructing the idle computing device with the lower device power demand to execute the requested application.

[B2] In some embodiments, the method of [B1] further includes comparing the lower device power demand to a rack power overhead, and, when the lower device power demand is less than the rack power overhead, instructing the idle computing device to execute the requested application.

[B3] In some embodiments, the first idle computing device and the second idle computing device of [B1] or [B2] have the same hardware architecture.

[B4] In some embodiments, the first idle computing device and the second idle computing device of any of [B1] through [B3] are game console computing devices.

[C1] In some embodiments, a method for managing computational and power resources in a datacenter includes receiving telemetry information from a computing device executing an application, obtaining an efficiency parameter for the computing device, wherein the efficiency parameter indicates how power efficient the computing device is relative to an ideal computing device of the same hardware architecture, and calculating a normalized power demand for the application based at least partially on the efficiency parameter and the telemetry information.

[C2] In some embodiments, the method of [C1] includes receiving telemetry information from a plurality of computing devices with efficiency parameters executing the application.

[C3] In some embodiments, the normalized power demand of [C1] or [C2] is a peak power demand for the application.

[C4] In some embodiments, the normalized power demand of [C1] or [C2] is an average power demand for the application.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for managing computational and power resources in a datacenter, the method comprising:
receiving an application request at an allocator to execute a requested application;
identifying an idle computing device in the datacenter;
obtaining an efficiency parameter for the idle computing device;
obtaining a normalized power demand of the requested application; and
determining a device power demand for the requested application on the idle computing device based at least partially on the efficiency parameter and a normalized power demand for the requested application.

2. The method of claim 1, wherein the efficiency parameter is received from the idle computing device.

3. The method of claim 1, wherein the efficiency parameter is obtained from a device inventory.

4. The method of claim 1, wherein the normalized power demand is selected from a set of normalized power demands for the requested application.

5. The method of claim 4, wherein the normalized power demand is selected from a set of normalized power demands at least partially based on one or more requested performance settings.

6. The method of claim 4, wherein the normalized power demand is selected from a set of normalized power demands at least partially based on one or more hardware parameters of the idle computing device.

7. The method of claim 1, further comprising:
comparing the device power demand to a rack power overhead; and
when the device power demand is less than the rack power overhead, instructing the idle computing device to execute the requested application.

8. The method of claim 1, wherein the requested application is stored locally on a hardware storage device of the idle computing device.

9. The method of claim 1, wherein the normalized power demand is calculated by measuring telemetry from a second computing device with a second efficiency parameter executing the requested application.

10. The method of claim 9, wherein the second computing device has the same hardware architecture as the idle computing device.

11. The method of claim 1, wherein the normalized power demand is calculated by a machine learning model that receives inputs from telemetry of a plurality of computing devices executing the requested application.

12. The method of claim 11, wherein at least one computing device of the plurality of computing devices has a hardware architecture different from the idle computing device.

13. A method for managing computational and power resources in a datacenter, the method comprising:
receiving an application request at an allocator to execute a requested application;
identifying a first idle computing device in the datacenter;
obtaining an efficiency parameter for the first idle computing device;
identifying a second idle computing device in the datacenter;
obtaining an efficiency parameter for the second idle computing device;
obtaining a normalized power demand of the requested application;
determining a first device power demand for the requested application on the first idle computing device based at least partially on the efficiency parameter and a normalized power demand for the requested application;
determining a second device power demand for the requested application on the second idle computing device based at least partially on the efficiency parameter and a normalized power demand for the requested application;
comparing the first device power demand to the second device power demand; and
instructing the idle computing device with the lower device power demand to execute the requested application.

14. The method of claim 13, further comprising:
comparing the lower device power demand to a rack power overhead; and
when the lower device power demand is less than the rack power overhead, instructing the idle computing device to execute the requested application.

15. The method of claim 13, wherein the first idle computing device and the second idle computing device have the same hardware architecture.

16. The method of claim 13, wherein the first idle computing device and the second idle computing device are game console computing devices.

17. A method of managing computational and power resources in a datacenter, the method comprising:
receiving telemetry information from a computing device executing an application;
obtaining an efficiency parameter for the computing device, wherein the efficiency parameter indicates how power efficient the computing device is relative to an ideal computing device of the same hardware architecture; and
calculating a normalized power demand for the application based at least partially on the efficiency parameter and the telemetry information.

18. The method of claim 17, further comprising receiving telemetry information from a plurality of computing devices with efficiency parameters executing the application.

19. The method of claim 17, wherein the normalized power demand is a peak power demand for the application.

20. The method of claim 17, wherein the normalized power demand is an average power demand for the application.
